(19) United States
(12) Patent Application Publication
(10) Pub. No.: US 2026/0156146 A1
(43) Pub. Date: Jun. 4, 2026

(54) SYSTEM AND METHOD FOR PROACTIVE DEFENSE AGAINST RANSOMWARE AND INFOSTEALER ATTACKS USING MOVING TARGET DEFENSE TECHNIQUE

(71) Applicant: KING FAHD UNIVERSITY OF PETROLEUM AND MINERALS, Dhahran (SA)

(72) Inventors: Soha Basher SANDOUKA, Dhahran (SA); Baber JAN, Dhahran (SA); Anas Ahmad ABUDAQA, Dhahran (SA); Ashraf Sharif Hasan MAHMOUD, Dhahran (SA); Talal Mousa ALKHAROBI, Dhahran (SA)

(73) Assignee: KING FAHD UNIVERSITY OF PETROLEUM AND MINERALS, Dhahran (SA)

(21) Appl. No.: 18/967,981

(22) Filed: Dec. 4, 2024

(51) Int. Cl. H04L 9/40; G06F 9/455

(52) U.S. Cl. CPC H04L 63/1466; G06F 9/45558; G06F 2009/45587

(57) ABSTRACT

A security system and method implements proactive defense through host operating system isolation and virtualization. The security system and method include a host computer running a host operating system and multiple hosted virtual machines that serve as intermediate connections to isolate the host operating system from external networks. The virtual machines systematically back up data to cloud services having indirect connections to the host computer. An internal virtual private network interconnects the virtual machines, with a designated virtual machine serving as a network gateway to manage traffic flow. A secure controller within the host computer functions as a bridge between user applications and the host operating system, enforcing security protocols and managing core operations to ensure system integrity. The secure controller manages interactions between the virtual machines and cloud services, providing security measures while maintaining operational efficiency through parallel processing architecture.

### STATEMENT OF ACKNOWLEDGEMENT

Support provided by King Fahd University of Petroleum and Minerals (KFUPM), the Department of Computer Engineering (COE), and the Interdisciplinary Research Center for Intelligent Secure Systems (IRC-ISS) is gratefully acknowledged.

### BACKGROUND

### Technical Field

The present disclosure is directed to computer security systems, and more particularly to a system and method for protecting computer systems and data from ransomware and infostealer attacks using network isolation, virtualization, and moving target defense techniques.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Ransomware and infostealer attacks have posed significant threats to the privacy and availability of digital data. Ransomware encrypts files or locks systems, making them inaccessible without a decryption key, which typically requires paying a ransom. Infostealer malware infiltrates systems to collect sensitive data, such as banking credentials, social media logins, and emails, and forwards it to attackers. Conventional cybersecurity techniques have primarily focused on a reactive approach to threats, often dealing with malware and cyber-attacks after they have breached system defenses. These methods include signature-based detection, where anti-malware relies on a database of known malware signatures to identify and block threats. However, this approach struggles with new or evolving malware that does not match existing signatures. Another method is behavior-based detection, which monitors system activities for unusual or suspicious behavior indicative of a cyber-attack. While more effective against zero-day threats, behavior-based detection can suffer from high false-positive rates, potentially disrupting legitimate system operations. Additionally, network security measures such as firewalls and intrusion detection systems (IDS) have been employed to monitor and control incoming and outgoing network traffic based on predetermined security rules. Despite their utility, these defenses can be circumvented by sophisticated cyber-attacks that exploit previously unknown vulnerabilities or use encryption and obfuscation to hide malicious activities. These challenges underscore the limitations of conventional cybersecurity techniques in the face of advanced threats like ransomware and infostealers, necessitating the development of more proactive and innovative strategies to safeguard digital data and systems.

Historically, the safeguarding of file systems against cyber threats, notably ransomware and infostealers, has evolved from basic encryption techniques to the more sophisticated adoption of Moving Target Defense (MTD) strategies. As these threats have grown in complexity, so too have the countermeasures designed to thwart them. The literature reveals a spectrum of techniques developed over the years to enhance file system security. The categories examined include Volume Encryptors, File System Encryptors, End-to-End Encryption Systems, Cryptographic File Systems, Steganographic File Systems, Distributed File Systems and the application of MTD principles. Efficacy of each technique can be evaluated against the critical security principles of confidentiality, integrity, availability and usability. In this context, usability critiques how security measures affect system performance and user experience, emphasizing efficient read/write operations and minimal disruption from security protocols.

The late 1990s and early 2000s introduced volume encryption as a foundational method for securing data within file systems. Systems like PGP Disk by Symantec's PGP Corporation, the Secure File System by Peter Gutmann [See: Gutmann P (1993) Secure File System] and TorDisk by Alexander Tormasov [See: Tormasov A (2001) TorDisk: A Secure Disk System] encrypted entire disk volumes at the device driver layer, aiming to ensure data confidentiality. Despite their effectiveness in enhancing confidentiality, these volume encryptors showed limitations in providing availability and in conducting adequate integrity checks, revealing gaps in their defense against advanced threats and posing potential compromises to usability and system performance.

Building on volume encryption, the field saw a shift towards file system encryptors that operated at the system level, offering more granular security measures. Innovations such as the Cryptographic File System (CFS) [See: Blaze M (1993) A Cryptographic File System for UNIX; and Blaze M (1994) Key Management in an Encrypting File System], the Transparent Cryptographic File System (TCFS) [See: Cattaneo G et al. (2001) The Design and Implementation of a Transparent Cryptographic File System for UNIX], and Microsoft's Encrypted File System (EFS) focused on encrypting data at the file system level. While these systems advanced data confidentiality and created barriers against unauthorized access, their effectiveness against ransomware remained uncertain. They highlighted the critical need for robust backup mechanisms to ensure data availability in the face of ransomware attacks or key loss, without significantly addressing the challenge of system usability in the context of advanced threats.

The advent of End-to-End Encryption (E2EE) systems, such as the Secure File System (SFS) [See: Mazières D et al. (2002) Separating key management from file system security] and NCryptfs [See: Wright C P et al. (2003) NCryptfs: A Secure and Convenient Cryptographic File System], marked a significant advancement by providing comprehensive security solutions that include data confidentiality, integrity, and access control mechanisms. These systems implemented sophisticated features like Access Control Lists (ACLs) in XML, smart cards for user authentication, and administrative functions through a Group Server, striving to overcome the limitations of previous encryption methods. However, the challenge of ransomware remained, with the potential for double encryption complicating decryption efforts. Despite these advancements, the critique of E2EE systems also emphasized the ongoing need for effective backup solutions and highlighted usability considerations, especially in handling large datasets and maintaining system performance.

Adding to the diversity of file system security enhancements, Steganographic File Systems, like StegFS [See: McDonald A D, Kuhn M G (2000) StegFS: A Steganographic File System for Linux], and Versioned File Systems, such as the Versioned Virtual Disk (VDisk) [See: Peterson Z et al. (2005) A Versioning Virtual Disk System], offer approaches to file system security by focusing on concealment and versioning, respectively. StegFS hides files within unused disk blocks, creating a challenge for ransomware and info stealers through security by obscurity, although this method may fail under advanced forensic scrutiny and complicates data recovery in system failures. Conversely, VDisk emphasizes data protection through block-level versioning, enabling recovery and integrity maintenance by logging every disk write and performing log cleaning, but it does not directly enhance confidentiality against unauthorized access.

Building on the diversified enhancements in file system security, the adoption of Distributed File Systems (DFS) marks a critical evolution, moving from centralized storage solutions to a decentralized architecture, as seen in the Secure Distributed File System (SDFS) [See: Yu S et al. (2017) A Secure Distributed File System Based on Hadoop]. This approach, designed for Hadoop-as-a-Service, optimizes data storage by distributing file segments across a network of computers, effectively emulating local storage accessibility while physically dispersing data. Such segmentation not only facilitates efficient storage and retrieval but also introduces advanced data management techniques like erasure coding, which significantly enhances redundancy and recovery capabilities.

Different Moving Target Defense (MTD) strategies have been developed to safeguard file systems against ransomware and infostealer threats. Lee et al. [See: Lee S et al. (2019) A Moving Target Defense Approach for Protecting Resource-Constrained Distributed Devices from Advanced Persistent Threats] proposed a method that randomly alters file extensions, while Khan et al. [See: Khan M S et al. (2020) Moving Target Defense for Securing Smart Grid Applications] implemented multi-layered proactive and reactive defense strategies. Assen et al. [See: Assen M et al. (2021) Moving Target Defense Framework for Smart Grid Security] introduced a comprehensive MTD framework, and the MTFS platform employs file system overlays [See: Chen Y et al. (2022) MTFS: A Moving Target File System]. Meanwhile, the MDFS architecture [See: Zhang H et al. (2023) MDFS: A Mimic Defense File System] leverages mimic defense theory, distributing data across various storage entities while using dynamic management modules.

Despite advancements in cybersecurity techniques against ransomware and infostealers, a gap remains in achieving high confidentiality and availability without compromising usability. The limitations of conventional approaches provide the need for improved computer security systems that implement proactive and dynamic defense mechanisms. Specifically, there remains a need for security systems that can protect computer systems and data against ransomware and infostealer attacks while maintaining system functionality and usability.

Accordingly, it is one object of the present disclosure to provide a security system for a file system and a method of securing a file system which implement proactive defense mechanisms for protecting file systems against unauthorized access and modification. Another object of the present disclosure is to provide a security system that maintains data availability while implementing enhanced security protocols, and enables secure data backup and recovery without requiring direct external network connections to protected systems.

### SUMMARY

In an exemplary embodiment, a security system for a file system is described, comprising: a host computer running a host operating system, and running a plurality of hosted virtual machines (VMs) as an intermediate connection to isolate the host operating system from external networks; and a plurality of cloud services having indirect connections to the host computer facilitated by the host operating system, wherein the plurality of VMs are configured to systematically back up data to the plurality of cloud services, wherein the plurality of VMs are interconnected to each other via an internal virtual private network, wherein a designated VM serves as a network gateway and manages traffic flow between the internal virtual private network and the external networks, including maintaining network security, wherein the host computer includes a secure controller configured as a bridge between user applications and the host operating system to enforce security protocols and manage core operations to ensure system integrity in the host computer, and wherein the secure controller is configured to manage interactions between the plurality of VMs and the plurality of cloud services.

In some embodiments, the designated VM is equipped with a Bridged Network Adapter for external access to the internet and an Internal Network Adapter for internal VM communications.

In some embodiments, the secure controller employs Moving Target Defense (MTD) for encoding files in the file system and secret sharing.

In some embodiments, the secure controller is configured to manage VM deployment, performance, and resource allocation while enforcing security policies, by continuously monitoring the plurality of VMs for indications of corruption or malicious activities.

In some embodiments, the file system is a host file system, wherein the secure controller manages a write command which instructs the host file system to perform a write operation, storing an original file, and concurrently initiating a backup process using the MTD, including dividing the original file into shares and distributing the shares among the VMs, and wherein each VM uploads its respective share to a designated cloud storage.

In some embodiments, the security system further comprises a host file system, wherein the secure controller manages a read command which instructs the host file system to perform a read operation, requesting a specified file from the host file system, and wherein if the specified file is not found, the secure controller initiates file recovery using the MTD.

In some embodiments, the MTB-based file recovery includes retrieving, by the secure controller, the file shares from VMs, wherein the secure controller seeks the corresponding share from the cloud storage, and wherein the secure controller determines whether the retrieved shares are enough for file reconstruction.

In some embodiments, the secure controller employs MTD including strategies of increasing diversity, shuffling parameters, adding redundancy, or using hybrid techniques that combine diversity, shuffling and redundancy.

In some embodiments, a hypervisor performs VM migration at specified intervals based on a trigger from an Intrusion Detection System, wherein the hypervisor selects a destination host to which an infected VM will be migrated, and deletes the infected VM on the host computer.

In some embodiments, the hypervisor further uploads file shares from the file system to an added VM to maintain data integrity, and updates a configuration of the network and connects the added VM to a cloud network.

In another exemplary embodiment, a method of securing a file system is described, comprising: running a host operating system, on a host computer; running a plurality of hosted virtual machines (VMs), on the host computer, as an intermediate connection to isolate the host operating system from external networks; systematically back up data, by the plurality of VMs, to a plurality of cloud services having indirect connections to the host computer facilitated by the host operating system; managing traffic flow, by a designated VM, between an internal virtual private network and the external networks, including maintaining network security; enforcing security protocols and managing core operations, by a bridge between user applications and the host operating system, to ensure system integrity in the host computer; and managing, by the secure controller, interactions between the plurality of VMs and the plurality of cloud services.

In some embodiments, the method further comprises accessing the internet, using the designated VM equipped with a Bridged Network Adapter; and conducting internal VM communications using an Internal Network Adapter.

In some embodiments, the method further comprises encoding, by the secure controller, files in the file system and secret sharing using Moving Target Defense (MTD).

In some embodiments, the method further comprises managing VM deployment, performance, and resource allocation, by the secure controller, while enforcing security policies, by continuously monitoring the plurality of VMs for indications of corruption or malicious activities.

In some embodiments, the file system is a host file system, and the method further comprises managing, by the secure controller, a write command which instructs the host file system to perform a write operation, storing an original file, and concurrently initiating a backup process using the MTD, including dividing the original file into shares and distributing the shares among the VMs; and uploading, by each VM, a respective share to a designated cloud storage.

In some embodiments, the method further comprises a host file system, and the method comprises managing, by the secure controller, a read command which instructs the host file system to perform a read operation, by requesting a specified file from the host file system; and when the specified file is not found, the secure controller initiates file recovery using the MTD.

In some embodiments, the MTB-based file recovery includes retrieving, by the secure controller, the file shares from VMs; seeking, by the secure controller, the corresponding share from the cloud storage; and determining, by the secure controller, whether the retrieved shares are enough for file reconstruction.

In some embodiments, the method further comprises employing, by the secure controller, MTD including strategies of increasing diversity, shuffling parameters, adding redundancy, or using hybrid techniques that combine diversity, shuffling and redundancy.

In some embodiments, the method further comprises performing, by a hypervisor, VM migration at specified intervals based on a trigger from an Intrusion Detection System; selecting, by the hypervisor, a destination host to which an infected VM will be migrated; and deleting, by the hypervisor, the infected VM on the host computer.

In some embodiments, the method further comprises uploading, by the hypervisor, file shares from the file system to an added VM to maintain data integrity; and updating, by the hypervisor, a configuration of the network and connecting the added VM to a cloud network.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary schematic diagram illustrating an overall architecture of a security system for a file system, according to certain embodiments.

FIG. 2 is an exemplary schematic diagram of a virtual private network configuration, illustrating role of virtual machines and network gateway, according to certain embodiments.

FIG. 3A is an exemplary flowchart of a write operation using Moving Target Defense (MTD) by the security system, according to certain embodiments.

FIG. 3B is an exemplary flowchart of a delete operation using MTD by the security system, according to certain embodiments.

FIG. 4 is an exemplary flowchart of a file reading operation and a file recovery operation using MTD by the security system, according to certain embodiments.

FIG. 5 is an exemplary flowchart of virtual machine (VM) migration in the security system, according to certain embodiments.

FIG. 6 is an exemplary flowchart listing steps involved in a method of securing a file system, according to certain embodiments.

FIG. 7 is an illustration of a non-limiting example of details of computing hardware used in a secure controller of the system, according to certain embodiments.

FIG. 8 is an exemplary schematic diagram of a data processing system used within the secure controller, according to certain embodiments.

FIG. 9 is an exemplary schematic diagram of a processor used with the secure controller, according to certain embodiments.

FIG. 10 is an illustration of a non-limiting example of distributed components which may share processing with a controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a security system for a file system and a method of securing a file system which implement isolation of a host operating system from external networks while maintaining indirect network connectivity through virtual machines. The security system and method focuses on proactive prevention by disconnecting critical systems from potentially harmful networks.

The present disclosure provides a “Zero Threat Zone,” which mitigates vulnerabilities by balancing security features with operational efficiency. This balanced approach forms the basis of the present disclosure, aiming to provide a comprehensive solution to protect file systems from emerging cyber threats. Furthermore, the approach to integrating security with usability in critical systems is a highly desirable cybersecurity strategy.

The ZTZ advances a proactive defense paradigm. The ZTZ ensures data integrity and system resilience by prioritizing system isolation from network threats, thus moving away from conventional reactive approaches. The emphasis of the security system on pre-emptive defense provides new insights for cybersecurity. Furthermore, the principles of this security system has an impact on data protection and cyber threat mitigation on a broad scale.

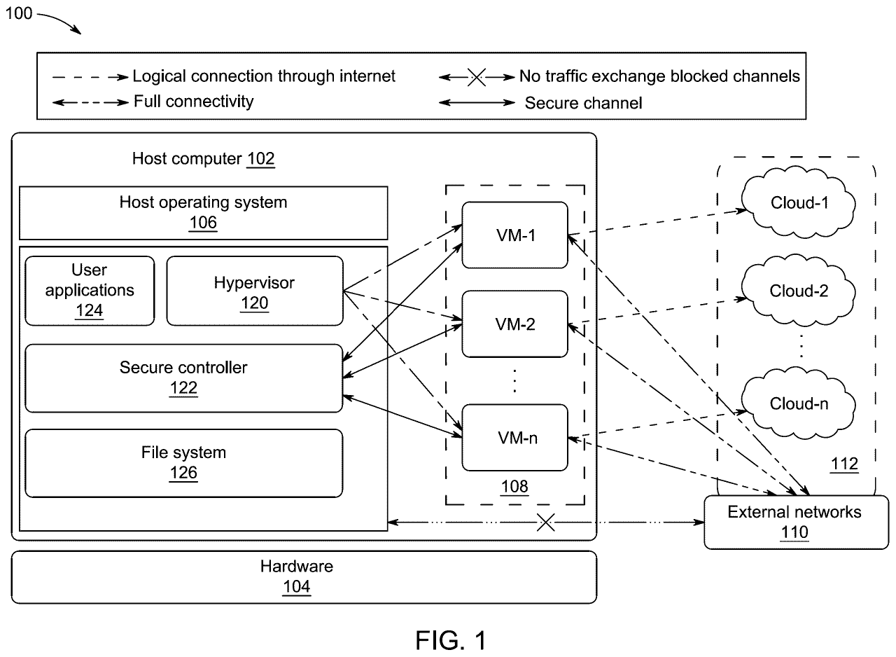

Referring to FIG. 1, illustrated is an exemplary schematic diagram of an overall architecture of a security system (as represented by reference numeral 100) for a file system. The security system 100 employs a multi-layered architecture that combines network isolation, virtualization, and Moving Target Defense (MTD) techniques to protect data and system resources. The security system 100 implements proactive defense mechanisms against unauthorized access and malicious software attacks. The security system 100 achieves this by establishing controlled communication paths between protected internal components and external resources while maintaining strict isolation of critical system elements. The architecture of the security system 100 provides systematic modification of the attack surface presented to potential threats through the implementation of MTD strategies.

As illustrated, the security system 100 includes a host computer 102. Herein, the host computer 102 refers to the physical computing device that provides hardware resources and executes system software components. As shown in FIG. 1, the host computer 102 is supported by a hardware layer 104. The host computer 102 runs a host operating system 106. Herein, the host operating system 106 refers to the core software system executing on the host computer 102 that manages hardware resources and provides core computing services. The host computer 102 also runs multiple hosted virtual machines VM-1, VM-2, through VM-n (herein, collectively referred to as “hosted virtual machines 108” or “VMs 108”). Herein, the multiple hosted virtual machines 108 refers to software-based emulations of computer systems that execute as isolated environments on the host computer 102, in which each hosted virtual machine 108 operates as an independent computing instance. In the security system 100, the multiple hosted virtual machines 108 is configured as an intermediate connection to isolate the host operating system 106 from external networks 110. Herein, the external networks 110 refer to networks outside the security boundary of the host computer 102, including internet connections and external communication infrastructure. This configuration of isolation of the host operating system 106 from the external networks 110 is indicated by blocked channel symbol between the host computer 102 and external networks 110 in FIG. 1.

The security system 100 further includes multiple cloud services Cloud-1, Cloud-2, through Cloud-n (hereinafter, collectively referred to as cloud services 112). Herein, the multiple cloud services 112 refers to external storage and computing resources that maintain data backups and provide additional computational capabilities that are delivered over the Internet. Cloud services are hosted by third-party providers, called cloud service providers (CSPs), and accessed through the Internet, in which each cloud service 112 operates as an independent storage and processing entity. The cloud services 112 have indirect connections to the host computer 102 facilitated by the host operating system 106. The cloud services 112 maintain these indirect connections to the host computer 102 through the hosted virtual machines 108. The indirect connections are represented by logical connection lines that extend from the hosted virtual machines 108 to the cloud services 112 in FIG. 1. The logical connections through the hosted virtual machines 108 enable secure communication between the host computer 102 and the external networks 110 while maintaining isolation of the host operating system 106.

The security system 100 implements a two-tiered backup approach utilizing both the multiple VMs 108 (which are local) and the cloud services 112. The VMs 108 provide immediate backup capability for the host operating system 106, while the cloud services 112 serve as a secondary backup mechanism. The multiple VMs 108 are configured to systematically back up data to the multiple cloud services 112. In one example, each of VMs 108 maintains connections to multiple cloud services Cloud-1 through Cloud-n, enabling distributed storage and redundant backup paths. In another example, each of the VMs 108 is provided a connection to a designated cloud storage from the cloud services 112. This dual-layer approach ensures data availability even in scenarios involving hardware failures or VM compromise.

In the security system 100, the hosted virtual machines 108 operate with defined security boundaries and maintain logical connections to external networks 110 while functioning under security constraints implemented by the security system 100. These constraints include network traffic monitoring, secure routing protocols, and traffic flow management between internal networks and external resources. The arrangement of hosted virtual machines 108 enables indirect access to essential external resources, such as cloud backups, while preserving the network isolation of the host operating system 106. The configuration of hosted virtual machines 108 implements a layered security approach where network isolation of the host operating system 106 is maintained through alternative networking methods. The hosted virtual machines 108 utilize additional hardware interfaces for bridged networking, enabling independent internet access for the virtual machines while preserving host system isolation. This approach aligns with network isolation principles while maintaining necessary operational connectivity for external communications and data backup operations.

Further, as illustrated in FIG. 1, the host computer includes a secure controller 122. The secure controller 122 is configured to manage interactions between the VMs 108 and the cloud services 112, through defined communication channels. These interactions are represented by the connection lines between the secure controller 122 and the hosted virtual machines 108, which then extend to the cloud services 112 through the logical connections, in FIG. 1. The security system 100 also includes a hypervisor 120 which is executed within the host computer 102 to manage the multiple virtual machines 108. The hypervisor 120 implements type 2 virtualization capabilities for creating and managing the execution environments of the hosted virtual machines 108. In the security system 100, the secure controller 122 maintains bidirectional communication paths with the hypervisor 120, and the hosted virtual machines 108, as indicated by the solid connection lines in FIG. 1.

The secure controller 122 is implemented within the host computer 102 and configured as a bridge between user applications 124 and the host operating system 106 to enforce security protocols and manage core operations to ensure system integrity in the host computer 102. The secure controller 122 operates within the host computer 102 as a security management component positioned between the user applications 124 and the host operating system 106. The secure controller 122 intercepts and processes all file system operations requested by the user applications 124 before these operations reach the host operating system 106. This bridging configuration enables the secure controller 122 to enforce security protocols across all file access operations and system interactions. The security system 100 further includes a file system 126 to manage data storage and retrieval operations. The file system 126 maintains communication with the secure controller 122 for coordinating file operations according to implemented security protocols. The user applications 124, within the host computer 102, interface with the file system 126 through the secure controller 122 to ensure that all file access operations are properly monitored and secured.

As discussed above, in the security system 100, the host computer 102 may implement network isolation by operating without direct connection to the external networks 110. This isolation is achieved through physical disablement of network interfaces on the host operating system 106 and/or implementation of firewall rules that block all direct external network traffic to the host operating system 106. Further, the hosted virtual machines 108 may create a controlled pathway for external communications while maintaining isolation of the host operating system 106. The hosted virtual machines 108 execute within isolated environments managed by the hypervisor 120, which provides virtualization capabilities for creating and managing virtual machine execution environments.

In an aspect, the secure controller 122 is configured to manage VM deployment, performance, and resource allocation while enforcing security policies, by continuously monitoring the VMs 108 for indications of corruption or malicious activities. For VM deployment, the secure controller 122 coordinates with the hypervisor 120 to create and configure new virtual machine instances according to defined security parameters and operational requirements. For performance monitoring mechanisms, the secure controller 122 tracks operational metrics of the hosted virtual machines 108. These monitoring operations include assessment of processing utilization, memory usage, storage capacity, and network bandwidth consumption for each hosted virtual machine 108. The secure controller 122 uses these performance metrics to optimize resource allocation and maintain operational efficiency across the virtualized environment. For resource allocation, the secure controller 122 distributes available computing resources among the hosted virtual machines 108 based on operational demands and security requirements. This resource allocation includes assignment of processing capacity, memory allocation, storage space, and network bandwidth to individual virtual machines 108 while maintaining defined performance thresholds. Further, for enforcing security policies, the secure controller 122 executes analysis of virtual machine behavior patterns, verification of data integrity, examination of network traffic patterns, and assessment of resource utilization anomalies. When the secure controller 122 detects indicators of corruption or malicious activities, the secure controller 122 initiates predefined response protocols, including isolation of affected virtual machines 108, initiation of virtual machine migration procedures, and implementation of recovery operations to maintain system security.

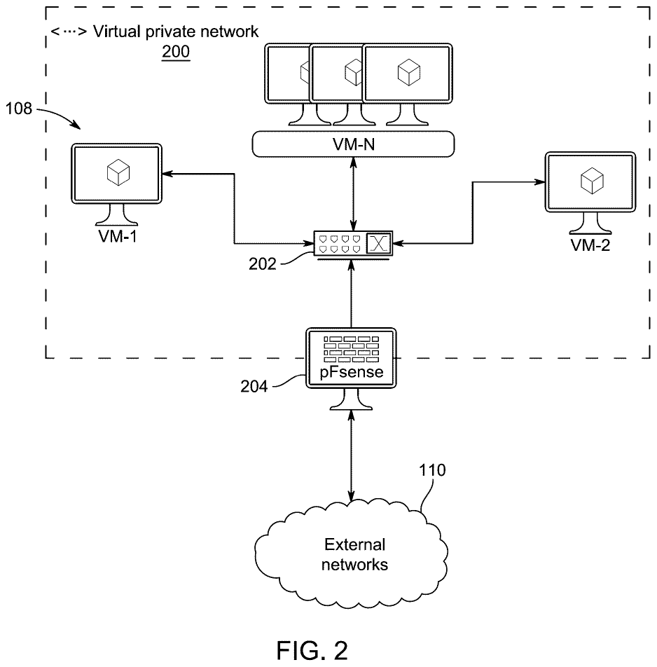

FIG. 2 illustrates a schematic representation of an internal virtual private network (VPN) 200 within the security system 100, depicting interconnections between the multiple VMs 108, for communication with the external networks 110. The internal virtual private network includes the 108, all interconnected through a network switch 202. The network switch 202 facilitates communications between all hosted virtual machines 108 within the internal VPN 200. The network switch 202 implements traffic routing and security filtering for all internal communications between the hosted virtual machines 108. The internal VPN 200 enables secure communication between virtual machine instances, by implementing encrypted communication channels for data transfer between the VMs 108, access control mechanisms for managing inter-virtual machine communications, traffic monitoring systems for security analysis, and network segmentation protocols for isolation of virtual machine operations. Thereby, the internal VPN 200 maintains separation from the external networks 110 while enabling coordinated operations between virtual machines 108.

A designated virtual machine (VM) 204 (as shown in FIG. 2) from among the multiple VMs 108 serves as a network gateway and manages traffic flow between the internal VPN 200 and the external networks 110, including maintaining network security. The designated VM 204, as the network gateway, may implement firewall rules, performs port forwarding operations under secure controller 122 oversight, and maintains security protocols for all network communications, for managing such traffic flow. The designated VM 204 manages all traffic flow between the interconnected virtual machines 108 and external network connections through defined security protocols and routing mechanisms. In particular, the designated VM 204 maintains isolated communication paths between components of the internal VPN 200 and the external network 110. In an example configuration, this isolation is achieved through pFsense firewall implementation, which enforces security policies and traffic management rules for all network communications crossing the virtual private network boundary.

In an aspect, the designated VM 204 is equipped with a Bridged Network Adapter (not shown) for external access to the internet and an Internal Network Adapter (not shown) for internal VM communications. This designated VM 204, serving as the network gateway, controls all traffic flow between the internal VPN 200 and the external networks 110. The Bridged Network Adapter provides external access to the internet, enabling the designated VM 204 to establish direct connections with external networks 110. This Bridged Network Adapter operates independently from network configuration of the host operating system 106, maintaining separation between external communications and operations of the host computer 102. The Internal Network Adapter within the designated VM 204 enables internal virtual machine communications across the internal VPN 200. This Internal Network Adapter establishes dedicated communication channels between the multiple VMs 108, facilitating protected data transfer and operational coordination between virtual machine instances. In general, the Bridged Network Adapter enforces security measures for internet traffic while the Internal Network Adapter maintains protected pathways for inter-virtual machine data transfer, ensuring separation between external access and internal operations.

In present aspects, the secure controller 122 employs Moving Target Defense (MTD) for encoding files in the file system 126 and secret sharing. The MTD technique implementation includes dynamic modification of encoding schemes for each write operation, with encoding scheme selection based on randomization algorithms. The secure controller 122 manages core operations including handling read, write, and delete commands while performing integrity checks using Cyclic Redundancy Check and hashing mechanisms to prevent data corruption and unauthorized modifications. In general, the secure controller 122 employs MTD through implementation of multiple strategic approaches for protecting the security system 100. The implementation of MTD techniques by the secure controller 122 addresses three fundamental aspects: selection of elements to move, determination of movement methods, and timing of movements. The secure controller 122 identifies different attack surfaces within the security system 100 that attackers may exploit, including surfaces at network, platform, application, and data levels. The secure controller 122 implements continuous changes to these attack surfaces to create uncertainty for potential attackers and extend the time required for attack execution.

For encoding files in the file system 126, the secure controller 122 implements data encoding processes that transform data into new formats using specific schemes. The encoding implementation is reversible, enabling the secure controller 122 to encode data into new formats and decode data back to original formats when required. The secure controller 122 utilizes encoding schemes including Base64 and hexadecimal encoding [See: Josefsson S (2003) The Base16, Base32, and Base64 Data Encodings, incorporated herein by reference in its entirety] for concealing original file content. The secure controller 122 executes dynamic changes to encoding schemes with each write operation performed on the file system 126. The selection of encoding schemes is implemented through a randomization process. The secure controller 122 maintains a set of encoding schemes for rotation, including Base64, which represents binary data in ASCII format using 64 characters, and hexadecimal encoding, which converts data to a base-16 representation using characters 0-9 and A-F. During read operations, the secure controller 122 reverses the process by selecting appropriate decoding schemes based on the encoding methods used during write operations.

Further, for implementing secret sharing, the secure controller 122 employs cryptographic techniques to fragment files into multiple shares and distribute these shares among the hosted virtual machines 108. The secure controller 122 implements Shamir's Secret Sharing [See: Pundkar S N, Shekokar N (2016) Cloud computing security in multi-clouds using Shamir's secret sharing scheme, incorporated herein by reference in its entirety] as the basis for file distribution, which enables reconstruction of original files only when a predefined threshold number of shares are combined. During write operations, after the file encoding process, the secure controller 122 utilizes secret sharing schemes to divide each original file into a defined number of fixed-size shares. The secure controller 122 implements a threshold mechanism that determines the minimum number of shares required for file reconstruction, ensuring that no single virtual machine 108 maintains a complete file. The distribution of shares across the hosted virtual machines 108 is executed through both time-based and event-based approaches.

Herein, in the time-based distribution approach, the secure controller 122 executes share distribution with each write operation, dividing files into small shares and distributing these shares across different virtual machines 108. This distribution method prevents attackers from predicting the location of specific file shares. In the event-based distribution approach, the secure controller 122 initiates dynamic redistribution of shares across virtual machines 108 in response to specific security alerts or detected threats.

For file reconstruction during read operations, the secure controller 122 implements collection and combination of the threshold number of shares. This implementation ensures that successful file reconstruction requires compromise of multiple virtual machines 108, as acquisition of shares from a single virtual machine 108 is insufficient for file recovery. The secure controller 122 performs integrity verification on reconstructed files to detect any alterations that may have occurred during the reconstruction process.

In an aspect of the present disclosure, the secure controller 122 employs MTD including strategies of increasing diversity, shuffling parameters, adding redundancy, or using hybrid techniques that combine diversity, shuffling and redundancy. For increasing diversity, the secure controller 122 implements variations in system configurations, encoding schemes, and operational parameters. This diversity implementation includes dynamic modification of encoding methods for stored data, variation of virtual machine configurations, and alteration of network communication patterns within the hosted virtual machines 108. For shuffling parameters, the secure controller 122 systematically modifies system attributes according to defined intervals or security triggers. These shuffling operations include rotation between different encoding schemes during file operations, modification of virtual machine network configurations, and alteration of data distribution patterns across the hosted virtual machines 108 and the cloud services 112. For adding redundancy, the secure controller 122 creates multiple backup mechanisms and parallel processing paths. The redundancy strategy includes distribution of file shares across multiple hosted virtual machines 108, replication of critical data across different cloud services 112, and maintenance of alternate communication paths between system components. The secure controller 122 combines these strategies into hybrid techniques that simultaneously implement diversity, shuffling, and redundancy. These hybrid techniques include dynamic modification of file encoding schemes while maintaining multiple backup copies, rotation of virtual machine configurations while preserving redundant processing paths, and variation of network routing patterns while maintaining multiple communication channels. The secure controller 122, thereby, creates multiple layers of dynamic defense against potential security threats while preserving system functionality and data availability.

In an aspect, the file system 126 is a host file system. The secure controller 122 manages a write command which instructs the host file system 126 to perform a write operation, storing an original file, and concurrently initiating a backup process using the MTD, including dividing the original file into shares and distributing the shares among the VMs 108. When executing the write operation, the secure controller 122 first stores the original file in the host file system 126. Concurrently, the secure controller 122 initiates the MTD-based backup process that includes encoding the original file using dynamically selected encoding schemes, dividing the encoded file into multiple shares using secret sharing algorithms, and distributing these shares across the VMs 108 according to defined security parameters. Herein, each hosted virtual machine 108 uploads its respective share to a designated cloud storage. That is, each hosted virtual machine 108 then executes an upload operation to transfer its assigned file share to a specifically designated cloud service 112, with the secure controller 122 monitoring the entire process to verify successful completion and maintain security protocols.

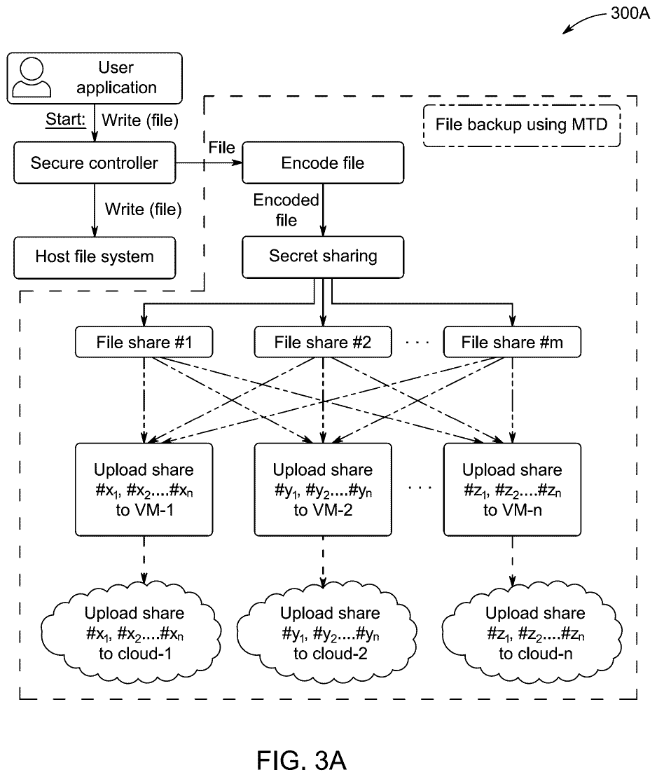

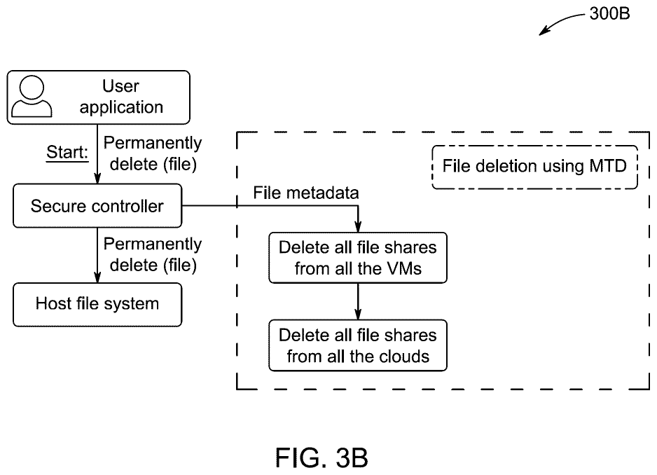

Referring to FIG. 3A, illustrated is an exemplary flowchart of a process (as represented by reference numeral 300A) of a write operation using MTD by the security system 100. The process 300A begins when a user application 124 initiates a write operation by sending a write command for a file to the secure controller 122. Upon receiving the write command, the secure controller 122 executes two parallel processes: a direct write operation to the host file system 126, and a file backup process using MTD techniques (as indicated within the dashed boundary). Within the MTD backup process, the original file undergoes an encode file operation that implements dynamically selected encoding schemes. The encoded file is then processed through a secret sharing operation that generates multiple file shares, designated as file share #1 through file share #m. The generated file shares are distributed across the multiple VMs 108 through dedicated upload operations. Each upload operation transfers specific file shares to designated virtual machines 108. The distribution paths, represented by dashed lines, indicate that each file share may be assigned to any of the available virtual machines 108, implementing the dynamic nature of the MTD strategy. Following the virtual machine upload operations, each hosted virtual machine 108 executes a subsequent upload operation to transfer its assigned shares to designated cloud services 112. The process 300A maintains parallel execution paths, enabling simultaneous storage of the original file in the host file system 126 and distribution of encoded file shares across the virtual machines 108 and cloud services 112. This parallel processing approach ensures efficient writing operation while implementing the security measures required by the MTD strategy.

Referring to FIG. 3B, illustrated is an exemplary flowchart of a process (as represented by reference numeral 300B) of a delete operation using MTD by the security system 100. The process 300B begins when a user application 124 initiates a deletion operation by sending a permanent delete command for a file to the secure controller 122. Upon receiving the delete command, the secure controller 122 executes parallel deletion processes: a direct deletion operation on the host file system 126, and a file deletion process using MTD techniques (as indicated within the dashed boundary). For the direct deletion operation, the secure controller 122 instructs the host file system 126 to execute a permanent delete operation for the specified file. Concurrently, the secure controller 122 initiates the MTD-based deletion process using the file metadata to locate all distributed copies and shares of the file across the security system 100. Within the MTD deletion process, the secure controller 122 first executes a deletion operation to remove all file shares from all virtual machines 108. This operation ensures complete removal of file shares that were previously distributed across the hosted virtual machines 108 during the write operation. Following the virtual machine cleanup, the secure controller 122 extends the deletion process to the cloud services 112, executing a deletion operation to remove all corresponding file shares from all cloud storage platforms. The process 300B maintains parallel execution paths, enabling simultaneous removal of the original file from the host file system 126 and deletion of all distributed file shares from both virtual machines 108 and cloud services 112. This parallel processing approach ensures efficient delete operation while maintaining the security protocols established by the MTD strategy.

In an aspect, the security system 100 further includes the host file system 126. Herein, the secure controller 122 manages a read command which instructs the host file system 126 to perform a read operation, requesting a specified file from the host file system 126. During read operations, the secure controller 122 first attempts to retrieve the requested file directly from the host file system 126. If the specified file is not found, the secure controller 122 initiates file recovery using the MTD. That is, when the specified file cannot be located in the host file system 126, indicating potential data corruption or system failure, the secure controller 122 automatically initiates the MTD-based file recovery process. This recovery initiation includes activation of file share retrieval procedures from the VMs 108 and, if necessary, from the cloud services 112, following defined security and verification protocols throughout the recovery process.

In an aspect, the MTD-based file recovery includes retrieving, by the secure controller 122, the file shares from the VMs 108. The secure controller 122 executes the MTD-based file recovery by first attempting to collect all distributed file shares from the VMs 108, implementing integrity verification checks on each retrieved share using hash validation mechanisms. Herein, the secure controller 122 seeks the corresponding share from the cloud storage (as part of the cloud services 112). That is, when shares from the VMs 108 are corrupted or unavailable, the secure controller 122 extends the retrieval process to the cloud services 112, seeking corresponding shares from designated cloud storage locations. Further, the secure controller 122 determines whether the retrieved shares are enough for file reconstruction. That is, after gathering available shares from both virtual machines 108 and cloud services 112, the secure controller 122 performs an assessment to determine if the quantity and quality of retrieved shares meet the threshold requirements for successful file reconstruction according to the implemented secret sharing algorithms and security parameters.

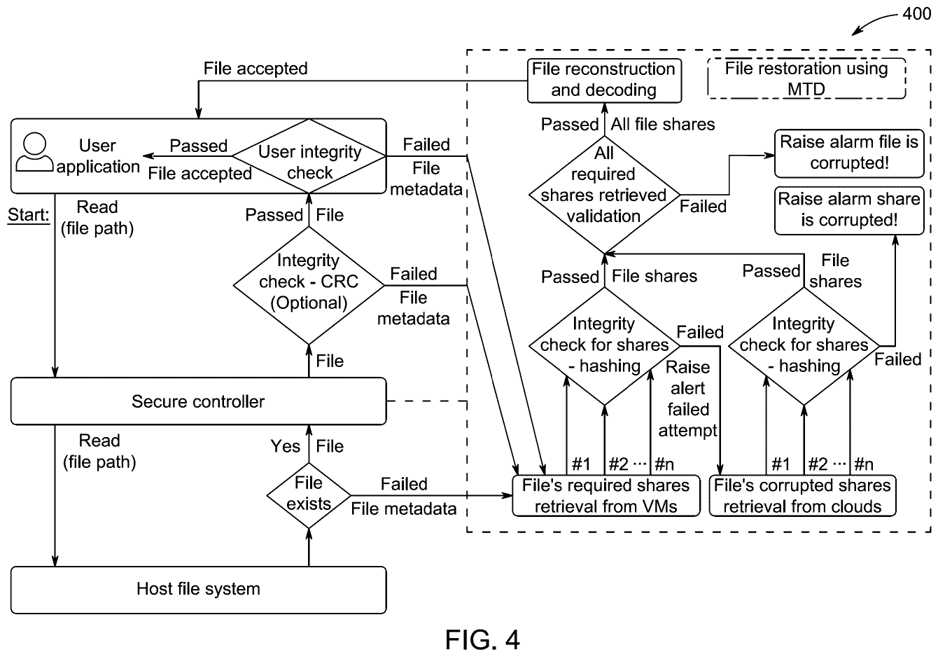

Referring to FIG. 4, illustrated is an exemplary flowchart of a process (as represented by reference numeral 400) of a read operation and a recovery operation using MTD by the security system 100. The process 400 begins when a user application 124 sends a read command with a file path to the secure controller 122. The secure controller 122 forwards this read request to the host file system 126 to check if the specified file exists. When the file exists in the host file system 126, the secure controller 122 retrieves the file and initiates an optional integrity check using Cyclic Redundancy Check (CRC). If the CRC check passes, the file is forwarded to the user application 124 for a user integrity check. Upon passing both checks, the file is accepted by the user application 124, completing the direct read path.

However, if the file does not exist in the host file system 126, or if either integrity check fails, the secure controller 122 initiates the file restoration using MTD (indicated within the dashed boundary). The restoration process begins with retrieval of required shares of the file from the VMs 108. Each retrieved share undergoes an integrity check using hashing mechanisms. If share integrity verification fails, the process extends to retrieving corrupted share(s) of the file from the cloud services 112. The retrieved shares, whether from the VMs 108 or the cloud services 112, undergo integrity validation through hashing. Failed integrity checks trigger appropriate alerts, like “Raise alarm share is corrupted!” for individual share corruption, or “Raise alarm file is corrupted!” for complete file corruption. When sufficient valid shares are collected, the process 400 proceeds to file reconstruction and decoding. The final stage involves validation of all required shares and completion of file reconstruction. Upon successful reconstruction, the decoded file is provided to the user application 124. Throughout the process 400, the secure controller 122 maintains verification checkpoints and alert mechanisms to ensure data integrity and security protocol compliance.

In an aspect of the present disclosure, the hypervisor 120 performs VM migration at specified intervals based on a trigger from an Intrusion Detection System (IDS). The hypervisor 120 implements two distinct migration approaches: scheduled migrations at predefined time intervals for proactive security, and reactive migrations triggered by security alerts from the IDS. The hypervisor 120 utilizes a scheduler component to manage the timing of virtual machine migrations. When the IDS detects potential security threats or anomalous behavior patterns within any hosted virtual machine 108, the IDS transmits trigger signals to the hypervisor 120. Upon receiving these trigger signals, the hypervisor 120 initiates an immediate migration sequence for the potentially compromised virtual machine. During these migration operations, the hypervisor 120 selects a destination host to which an infected virtual machine, from the VMs 108, will be migrated. The destination host selection process performed by the hypervisor 120 includes evaluation of available hardware resources, verification of security requirements, and assessment of network connectivity parameters. Further, the hypervisor 120 deletes the infected virtual machine from the host computer 102. After confirming successful migration to the destination host, the hypervisor 120 implements a secure deletion process for the infected virtual machine on the host computer 102. This deletion process includes removal of all virtual machine files, configuration data, and associated resources from the host computer 102. The hypervisor 120 then coordinates with the secure controller 122 to update network configurations and reestablish secure connections between the migrated virtual machine at the destination host and other system components, including the remaining hosted virtual machines 108 and cloud services 112.

In an aspect of the present disclosure, the hypervisor 120 executes additional operations following virtual machine migration or when adding new virtual machines to the security system 100. The hypervisor 120 uploads file shares from the file system 126 to an added virtual machine, from the VMs 108, to maintain data integrity. across the security system 100. This upload process includes transfer of all relevant file shares that were previously distributed across other virtual machines, ensuring continuation of the distributed storage arrangement implemented by the MTD strategies. The hypervisor 120 coordinates with the secure controller 122 to determine the appropriate distribution of file shares to maintain required redundancy levels and security parameters within the security system 100. The hypervisor 120 further updates a configuration of the network and connects the added VM to a cloud network. That is, following the file share upload process, the hypervisor 120 updates a configuration of the internal VPN 200 to incorporate the added virtual machine. This network configuration update includes modification of routing tables, security policies, and access control parameters within the network switch 202 and the designated VM 204. The hypervisor 120 then connects the added virtual machine to the cloud network by establishing secure communication channels between the added virtual machine and the designated cloud services 112.

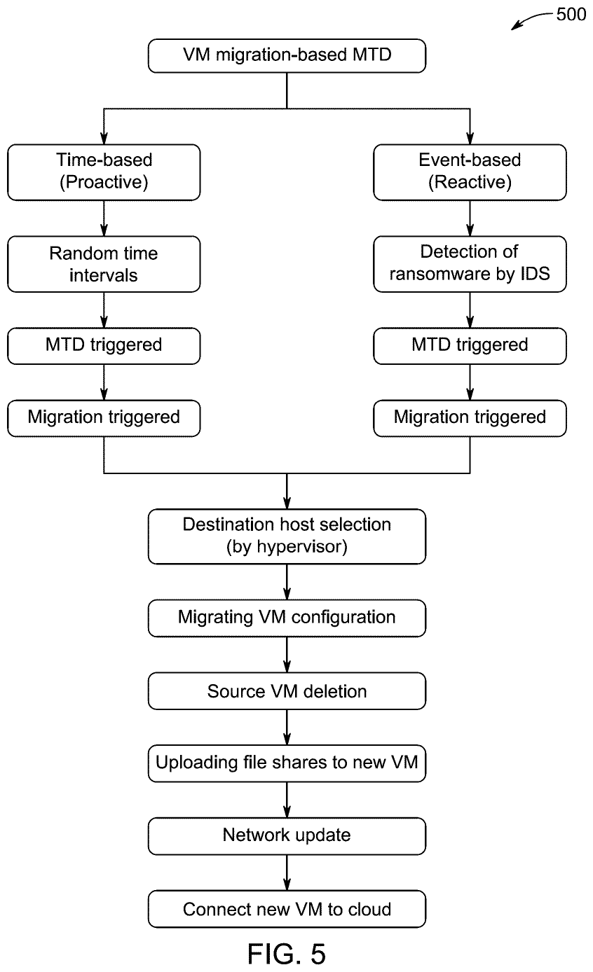

Referring to FIG. 5, illustrated is an exemplary flowchart of a process (as represented by reference numeral 500) of virtual machine migration-based Moving Target Defense (MTD) implemented by the security system 100. The process 500 depicts two parallel migration trigger paths: a time-based proactive approach and an event-based reactive approach. In the time-based proactive path, the process 500 is initiated based on random time intervals (such as daily, weekly, etc.) determined by the hypervisor 120. When these intervals are reached, the process 500 triggers the MTD mechanism, which subsequently activates the migration sequence. In the parallel event-based reactive path, the process 500 initiates upon detection of ransomware by the IDS. This detection also triggers the MTD mechanism, leading to activation of the migration sequence. Both paths converge at the destination host selection stage, where the hypervisor 120 selects an appropriate destination host for the VM migration. Following destination host selection, the process 500 proceeds through a sequence of operations: migrating virtual machine configurations from the source to the destination host, executing source virtual machine deletion from the host computer 102, and uploading file shares to the new virtual machine. The final stages of the process 500 involve network configuration updates and cloud connectivity establishment. The hypervisor 120 updates the network configuration to integrate the new virtual machine into the existing network structure. The process 500 ends with connecting the new virtual machine to the cloud services 112, ensuring continuity of backup operations and system functionality.

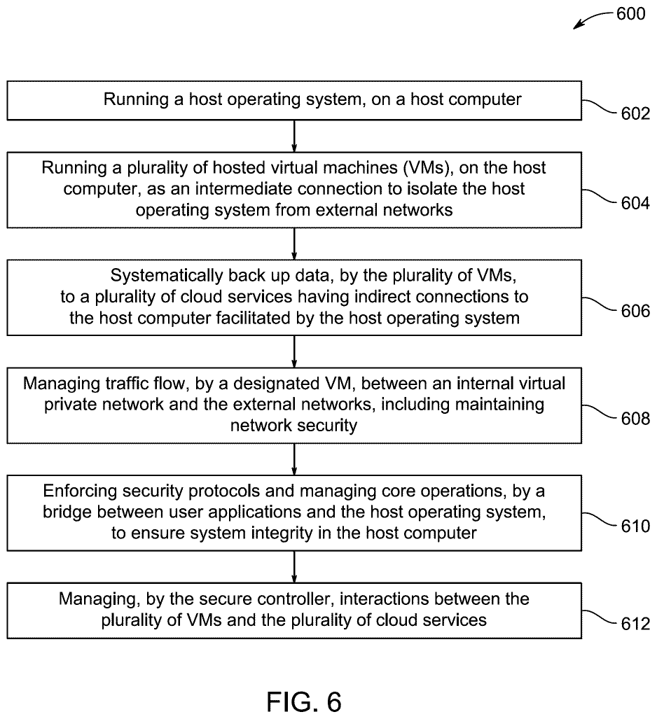

Referring now to FIG. 6, illustrated is an exemplary flowchart listing steps involved in a method (as represented by a flowchart, referred by reference numeral 600) of securing a file system (such as, the file system 126). The method 600 includes a series of steps. These steps are only illustrative, and other alternatives may be considered where one or more steps are added, one or more steps are removed, or one or more steps are provided in a different sequence without departing from the scope of the present disclosure. Various variants disclosed above, with respect to the aforementioned security system 100 apply mutatis mutandis to the present method 600.

At step 602, the method 600 includes running the host operating system 106, on the host computer 102. Herein, the method 600 executes the host operating system 106 on the host computer 102. The host operating system 106 provides core computing functionality while maintaining isolation from the external networks 110. The execution of the host operating system 106 includes implementation of security barriers and network interface controls that prevent direct external network connections to the host computer 102.

At step 604, the method 600 includes running the plurality of hosted virtual machines (VMs) 108, on the host computer 102, as an intermediate connection to isolate the host operating system 106 from the external networks 110. Herein, the method 600 executes a plurality of hosted virtual machines 108 on the host computer 102, configuring these virtual machines as intermediate connections between protected system components and the external networks 110. The hosted virtual machines 108 execute within isolated environments managed by the hypervisor 120, enabling controlled external communications while maintaining isolation of the host operating system 106 from direct network access.

At step 606, the method 600 includes systematically backing up data, by the plurality of VMs 108, to the plurality of cloud services 112 having indirect connections to the host computer 102 facilitated by the host operating system 106. The method 600 implements systematic backup procedures in which the plurality of hosted virtual machines 108 transfer and store data across the plurality of cloud services 112 using an orderly, methodical process. Each hosted virtual machine 108 maintains connections to multiple cloud services 112, creating distributed storage paths and redundant backup mechanisms. The backup operations execute according to defined intervals and security parameters managed by the secure controller 122.

At step 608, the method 600 includes managing traffic flow, by the designated VM 204, between the internal virtual private network 200 and the external networks 110, including maintaining network security. The method 600 implements traffic management through the designated VM 204, controlling data flow between the internal VPN 200 and the external networks 110. The designated VM 204 executes security protocols, implements firewall rules, and maintains network isolation while enabling necessary external communications through controlled pathways.

At step 610, the method 600 includes enforcing security protocols and managing core operations, by a bridge between the user applications 124 and the host operating system 106, to ensure system integrity in the host computer 102. That is, the method 600 implements security enforcement through the secure controller 122, which functions as a bridge between user applications 124 and the host operating system 106. The secure controller 122 executes security protocols across all system operations, manages file access controls, and maintains system integrity through continuous monitoring and verification procedures.

At step 612, the method 600 includes managing, by the secure controller 122, interactions between the plurality of VMs 108 and the plurality of cloud services 112. Herein, the method 600 executes management of interactions between the plurality of hosted virtual machines 108 and the plurality of cloud services 112 through the secure controller 122. This management includes coordination of data transfers, verification of security protocols, and maintenance of secure communication channels between virtual machines and cloud storage resources.

In an aspect, the method 600 includes accessing the internet, using the designated VM 204 equipped with a Bridged Network Adapter; and conducting internal VM communications using an Internal Network Adapter. Herein, the method 600 implements network configuration procedures in which the designated VM 204 executes internet access operations using the Bridged Network Adapter. The Bridged Network Adapter establishes external network connections while maintaining security protocols. Concurrently, the method 600 implements internal communication procedures in which the Internal Network Adapter facilitates protected data transfer operations between the plurality of hosted virtual machines 108 within the internal virtual private network.

In an aspect, the method 600 further includes encoding, by the secure controller 122, files in the file system 126 and secret sharing using Moving Target Defense (MTD). Herein, the method 600 implements file protection procedures in which the secure controller 122 executes encoding operations on files within the file system 126 and implements secret sharing using MTD techniques. The encoding process includes dynamic selection of encoding schemes that change with each write operation, while the secret sharing implementation fragments files into multiple shares for distribution across the plurality of hosted virtual machines 108. The MTD implementation includes continuous modification of encoding schemes and share distribution patterns to prevent prediction of security mechanisms.

In an aspect, the method 600 further includes managing VM deployment, performance, and resource allocation, by the secure controller 122, while enforcing security policies, by continuously monitoring the plurality of VMs 108 for indications of corruption or malicious activities. Herein, the method 600 executes virtual machine management procedures in which the secure controller 122 handles deployment of new virtual machines, monitors performance metrics, and manages resource allocation while enforcing defined security policies. The management process includes continuous monitoring of the plurality of VMs 108 for detecting corruption indicators or malicious activities. The secure controller 122 implements response protocols when anomalies are detected, including isolation of affected virtual machines and initiation of recovery procedures.

In an aspect, the file system 126 is the host file system and the method 600 further includes managing, by the secure controller 122, a write command which instructs the host file system 126 to perform a write operation, storing an original file, and concurrently initiating a backup process using the MTD, including dividing the original file into shares and distributing the shares among the VMs 108; and uploading, by each VM 108, a respective share to a designated cloud storage. Herein, the method 600 implements file operation procedures in which the file system 126 operates as a host file system. The secure controller 122 manages write commands that instruct the host file system 126 to perform write operations, storing original files while concurrently initiating backup processes using MTD techniques. The backup processes include division of original files into shares and distribution of these shares across the plurality of hosted virtual machines 108. Each hosted virtual machine 108 then executes upload operations to transfer assigned file shares to designated cloud services 112, creating distributed backups of original files across multiple storage locations.

In an aspect, the file system 126 is the host file system and the method 600 further includes managing, by the secure controller 122, a read command which instructs the host file system 126 to perform a read operation, by requesting a specified file from the host file system 126; and when the specified file is not found, the secure controller 122 initiates file recovery using the MTD. Herein, the method 600 executes file retrieval procedures in which the secure controller 122 manages read commands directed to the host file system 126. The secure controller 122 processes read operations by requesting specified files from the host file system 126. When requested files cannot be located in the host file system 126, the secure controller 122 initiates file recovery procedures using MTD techniques. These recovery procedures implement systematic retrieval of file components from distributed storage locations.

In an aspect, the MTB-based file recovery includes retrieving, by the secure controller 122, the file shares from VMs 108; seeking, by the secure controller 122, the corresponding share from the cloud storage; and determining, by the secure controller 122, whether the retrieved shares are enough for file reconstruction. Herein, the method 600 implements MTD-based file recovery procedures in which the secure controller 122 executes retrieval operations for file shares from the plurality of hosted virtual machines 108. When necessary, the secure controller 122 extends retrieval operations to seek corresponding shares from the cloud services 112. The secure controller 122 executes evaluation procedures to determine whether the quantity and integrity of retrieved shares meet threshold requirements for file reconstruction. These procedures may include verification of share integrity and validation of reconstruction parameters.

In an aspect, the method 600 further includes employing, by the secure controller 122, MTD including strategies of increasing diversity, shuffling parameters, adding redundancy, or using hybrid techniques that combine diversity, shuffling and redundancy. Herein, the method 600 implements comprehensive MTD strategies in which the secure controller 122 executes multiple protective approaches. These approaches include increasing diversity through variation of system configurations and encoding schemes, implementing parameter shuffling through systematic modification of system attributes, and adding redundancy through maintenance of multiple backup mechanisms. The secure controller 122 combines these approaches into hybrid techniques that simultaneously implement diversity, shuffling, and redundancy to create multiple layers of dynamic defense while preserving system functionality.

In an aspect, the method 600 further includes performing, by the hypervisor 120, VM migration at specified intervals based on a trigger from the Intrusion Detection System; selecting, by the hypervisor 120, a destination host to which an infected VM will be migrated; and deleting, by the hypervisor 120, the infected VM on the host computer 102. Herein, the method 600 implements virtual machine migration procedures in which the hypervisor 120 executes migration operations at specified intervals based on triggers received from the IDS. The hypervisor 120 implements both scheduled migrations at predefined intervals for proactive security and reactive migrations in response to security alerts from the IDS. The selection procedures executed by the hypervisor 120 identify appropriate destination hosts for infected virtual machines, considering hardware resources, security requirements, and network connectivity parameters. Following successful migration, the hypervisor 120 implements secure deletion procedures to remove infected virtual machines from the host computer 102, including removal of virtual machine files, configuration data, and associated resources.

In an aspect, the method 600 further includes uploading, by the hypervisor 120, file shares from the file system 126 to an added VM to maintain data integrity; and updating, by the hypervisor 120, a configuration of the network and connecting the added VM to a cloud network. Herein, the method 600 executes post-migration procedures wherein the hypervisor 120 implements file share upload operations from the file system 126 to newly added virtual machines. These upload operations ensure continuation of the distributed storage arrangement implemented by MTD strategies. The hypervisor 120 then executes network configuration updates to integrate new virtual machines into the existing network structure. These updates include modification of routing tables, security policies, and access control parameters within the network switch 202 and the designated VM 204. The hypervisor 120 establishes connections between new virtual machines and the cloud services 112, implementing secure communication channels and verifying proper integration with existing system components. The hypervisor 120 coordinates these operations with the secure controller 122 to maintain compliance with established security protocols and backup requirements of the security system 100.

### Evaluation

The security system 100, proposing the ZTZ model, is evaluated for its effectiveness against various cybersecurity threats and its usability in practical applications. The evaluation encompassed performance of the security system 100 (“system”) against hardware failures, cyberattacks targeting different system components, and the impact of network isolation on user interaction.

The performance of the system is evaluated against potential attack scenarios, focusing on the three fundamental cybersecurity domains: confidentiality, integrity, and availability. The evaluation examines the security of components of the system, including the host operating system, virtual machines (VMs), and cloud storage, considering potential vulnerabilities and the effectiveness of implemented security measures.

With respect to hardware failures and corruptions, despite advancements in technology, hardware failures can pose an inherent risk in computing systems, with a reported annual failure rate of 1-3% in server environments. The security system addresses this vulnerability by deploying a dual backup strategy to ensure data availability and enhance data integrity. The first layer of backup utilizes VMs as an immediate backup source for the host OS, providing a reliable fallback for data recovery in the event of hardware corruption. In circumstances where both the host OS and VMs are compromised, cloud storage acts as a secondary backup layer, guaranteeing data retrievability under multiple failure conditions.

To further protect against hardware-induced file corruption, the system integrates robust integrity checks within modern file systems like EXT4, NTFS, and HFS+ that featured checksums, journaling, and Copy-on-Write (CoW) mechanisms. Additionally, the system supports optional user-enabled CRC checks and user-based integrity verification processes, allowing for thorough checks against data alterations due to hardware issues, thereby ensuring comprehensive data integrity.

In addressing attacks on the host operating system, the system employes network isolation of the host operating system as its primary security measure against cyberattacks, particularly effective against threats like ransomware or infostealer that depend on network access. This strategic isolation secures confidentiality by preventing malware from exfiltrating data and preserving integrity by mitigating risks associated with network-based attacks. In scenarios where the system may have been compromised via physical devices like USB drives, the reliance of the system on layered backups, including Virtual Machines (VMs) and cloud storage, ensures data availability and further bolsteres integrity.

The system employes a comprehensive, layered approach to secure virtual machines and cloud storage, crucial due to their internet connectivity. The VMs of the system are fortified with Intrusion Detection Systems (IDS) that continuously monitors for anomalies and threats, enhancing early detection capabilities. Additionally, the system utilizes Moving Target Defense (MTD) tactics, such as dynamically changing VM configurations and IP addresses, coupled with random interval VM migrations.

The cloud storage security within the system is strengthened by selecting trusted cloud services with robust security protocols, and continuous monitoring by the secure controller for anomalies or corrupted data shares. Upon detecting significant security concerns, a cloud migration process is activated, transferring data to a more secure or alternative cloud service, thereby mitigating potential data compromise risks.

The system protects data through secret sharing, where each VM or cloud service holds only data fragments, greatly reducing the risk of total data exposure during a breach. This fragmentation ensures that a compromise of any single VM or cloud service will not grant full file access. In cases of multiple VM or cloud service breaches, the reassembly of data fragments by attackers requires detailed knowledge of the dynamically adjusted secret sharing algorithm and parameters, such as polynomial degrees.

Recent high-profile cyberattacks, such as the Norton Healthcare data breach, the Boeing cyber incident, the 23andMe credential stuffing attack, Dole Food Company attack and the City of Oregon attack, underscored the vulnerabilities of systems handling sensitive data, particularly those where internet connectivity is not as important as security. These incidents demonstrate the devastating consequences of inadequate security measures, including data exposure, operational disruptions, and financial losses.

The secure controller recovery mechanism of the system is implemented through a user-defined passphrase set during the initial system setup. This deterministic approach ensures that the controller can be restored independently of other system components, maintaining the availability and functionality of the entire system.

In terms of usability evaluation, which is crucial for cybersecurity implementation, the system is assessed for the ease and efficiency with which users can interact with it. The evaluation focuses on user-file system interaction overhead and the implications of disconnecting the host OS from external networks.

The system is designed to minimize user-perceived overhead during core file operations. During write operations, users experience minimal overhead as backups to VMs are executed quickly within the same system. Cloud backups occur seamlessly in the background, with the secure controller autonomously resolving any backup errors, ensuring a smooth and almost unnoticeable process for the user.

File deletions from the user's perspective are instantaneous. The secure controller handles the removal of these files from VMs and cloud storage in the background, ensuring no user disruption. For regular file access where there are no hardware corruptions, the process is direct and efficient with no noticeable delays. In rare cases of hardware corruption, the controller quickly retrieves data from VMs with minimal delay, facilitated by the integration of VMs within the system and the secure controller's efficient design.

The strategic disconnection of critical systems, as provided by the system, from external networks underscores its security-first approach, deliberately reducing network accessibility to bolster data protection. This decision is rooted in the principle that heightened security might inversely affect usability, particularly crucial where direct network access is unnecessary for operational integrity. The system adeptly handles this trade-off by enhancing internal security measures, such as verifying software installations from physical storage through trusted vendors' public keys, thus maintaining essential operational functionality without significant usability compromise.

Comparative evaluation with existing approaches demonstrate advantages of the system. The system is compared against various cybersecurity approaches including volume encryption techniques such as PGP Disk, Secure File System [See: Gutmann P (1996) The secure filesystem (sfs) for dos windows, incorporated herein by reference in its entirety], and TorDisk [See: Tormasov A (1997) The tordisk project, incorporated herein by reference in its entirety]. While these volume encryptors show high confidentiality, they demonstrate limitations in providing availability and conducting adequate integrity checks. The system is also evaluated against file system encryptors including the Cryptographic File System (CFS) [See: Blaze M (1993), incorporated herein by reference in its entirety], Transparent Cryptographic File System (TCFS) [See: Mauriello E (1997) TCFS: Transparent Cryptographic File System, incorporated herein by reference in its entirety], and Microsoft's Encrypted File System (EFS). These systems, while advancing data confidentiality, show limitations in their effectiveness against ransomware attacks. End-to-End Encryption systems such as the Secure File System (SFS) [See: Hughes J P, Feist C J (2001) Architecture of the Secure File System, incorporated herein by reference in its entirety] and NCryptfs [See: Wright C P et al., incorporated herein by reference in its entirety] are also considered in the evaluation. These systems implement sophisticated features but face challenges with ransomware through potential double encryption complications.

The comprehensive evaluation extends to Moving Target Defense (MTD) implementations, comparing the system against various MTD approaches. A method proposed by Lee et al. [See: Lee S, Kim H K, Kim K (2019) Ransomware protection using the moving target defense perspective, incorporated herein by reference in its entirety] demonstrates randomly altering file extensions, while Khan et al. [See: Khan M M, Hyder M F, Khan S M, Arshad J, Khan M M (2022) Ransomware prevention using moving target defense based approach] implement multi-layered proactive and reactive defense strategies. Further comparisons include an MTD framework introduced by Assen et al. [See: von der Assen J, Celdrán A H, Sánchez P M S, Cedeno J, Bovet G, Pérez G M, Stiller B (2022) A Lightweight Moving Target Defense Framework for Multi-purpose Malware Affecting IoT Devices, incorporated herein by reference in its entirety], and the Moving Target File System (MTFS) platform [See: von der Assen J, Celdrán A H, Sefa R, Bovet G, Stiller B (2023) MTFS: a Moving Target Defense-Enabled File System for Malware Mitigation, incorporated herein by reference in its entirety] which employed file system overlays. The MDFS architecture [See: Lin Z, Li K, Hou H, Yang X, Li H (2017) MDFS: A mimic defense theory based architecture for distributed file system, incorporated herein by reference in its entirety] leveraged mimic defense theory, distributing data across various storage entities while using dynamic management modules.

The evaluation of the model along with the evaluation of related works is summarized in Table 1 below.

TABLE 1
Evaluation of Cybersecurity Approaches Against Ransomware and Info Stealers

| | | Confiden- | | Avail- | |
|---|---|---|---|---|---|
| | Method/Study | tiality | Integrity | ability | Usability |
| Volume | PGP Disk | High | None | None | Low |
| Encryption | Secure File System (Gutmann) | High | None | None | Low |
| Techniques | TorDisk (Tormasov) | High | None | None | Low |
| Integration of File | IBM's Distributed File System | High | Medium | Medium | Low |
| System Encryptors | Network Attached Secure Disks (NASD) | High | Medium | Medium | Low |
| | Microsoft's Encrypted File System | High | Medium | Low | Low |
| | (EFS) | | | | |
| | Secure File System (SFS) | High | High | None | Medium |
| End-to- | NCryptfs | High | None | None | Medium |
| End Encryption | Steganographic File System (StegFS) | High | Medium | Medium | Medium |
| Steganographic and | Versioned Virtual Disk (VDisk) | None | High | High | High |
| Versioned | Secure Distributed File System (SDFS) | High | High | Medium | Low |
| MTD | Ransomware protection using the | None | None | Medium | Medium |
| | moving target defense perspective | | | | |
| | Ransomware prevention using moving | None | None | Medium | Medium |
| | target defense based approach | | | | |
| | A Lightweight Moving Target Defense | Low | None | Medium | High |
| | Framework for Multi-purpose Malware | | | | |
| | Affecting IoT Devices | | | | |
| | MTFS | None | None | Medium | Medium |
| | MDFS | High | High | High | Low |
| ZTZ | Security System | High | High | High | High |

Comparative analysis demonstrate that while previous volume encryption techniques provide high confidentiality, they typically show no or limited integrity and availability features, with consistently low usability. Integration of file system encryptors generally improve upon this by offering medium integrity and availability, though usability remains a challenge. End-to-End encryption solutions bring high confidentiality but vary in their provision of integrity and availability features.

The comprehensive approach of the system, combining network isolation, MTD strategies, and multi-tiered backup mechanisms, demonstrate high performance across all evaluated metrics, including confidentiality, integrity, availability, and usability. This represents a significant advancement over existing solutions, particularly in scenarios requiring robust protection against modern cyber threats while maintaining operational efficiency. The evaluation of the system revealed its effectiveness in addressing the limitations identified in conventional approaches, particularly in scenarios where data security took precedence over continuous network connectivity. The implementation of MTD techniques across multiple system components, file encoding, secret sharing, and VM migration, provide a dynamic security environment that significantly complicates potential attack vectors while maintaining system usability. These evaluations and use cases demonstrate a capability of the system to provide comprehensive protection against both current and emerging cyber threats, while maintaining operational efficiency and user accessibility. The architecture of the system proves particularly valuable in environments where data security is paramount, offering a robust solution for protecting critical systems and sensitive information across various sectors and applications.

The implementation of the system is suitable for various use cases where individual machine critical systems can be separated from direct network vulnerabilities. The implementation assumes trust in the hardware of the machine, the pre-installed operating system, user files, and chosen applications, similar to the trust users have in new hardware and operating systems. Practical applications of the system include ensuring the security of patient data and life-support systems in the healthcare industry, protecting military and defense systems handling sensitive operations or classified information, safeguarding confidential data related to national security and citizen information in government agencies, ensuring the security of intellectual property and proprietary information in research and development institutions, and enhancing the security of critical infrastructure such as power grids, water treatment facilities, and transportation systems.

The security system 100 and the method 600 for the file system implements a comprehensive protection approach through isolation of the host operating system from external networks while maintaining operational connectivity through hosted virtual machines. The security system 100 achieves this protection through implementation of multiple Moving Target Defense layers, including dynamic file encoding, secret sharing, and virtual machine migration. The combination of network isolation with systematic backup procedures ensures both data protection and availability, while the secure controller 122 provides centralized management of security protocols across all system components.

The security system 100 overcomes limitations of conventional approaches that rely primarily on reactive defense mechanisms. Where conventional systems implement static encryption methods or signature-based detection that can be circumvented by sophisticated attacks, the present security system 100 employs continuous modification of the attack surface through MTD strategies. The implementation of indirect network connections through virtual machines eliminates vulnerabilities associated with direct external network access while preserving necessary connectivity. The distribution of file shares across multiple virtual machines and cloud services provides superior protection compared to traditional centralized storage approaches, as successful data compromise requires simultaneous access to multiple system components.

The security system 100 maintains operational efficiency while implementing comprehensive security measures. The parallel processing architecture enables simultaneous execution of file operations and backup procedures without introducing significant operational delays. The implementation of both proactive and reactive migration strategies provides enhanced protection against evolving threats while maintaining system availability. The combination of local virtual machine storage with cloud service backups ensures data availability even in cases of hardware failure or successful attacks, addressing limitations of conventional systems that rely solely on local or cloud-based storage solutions.

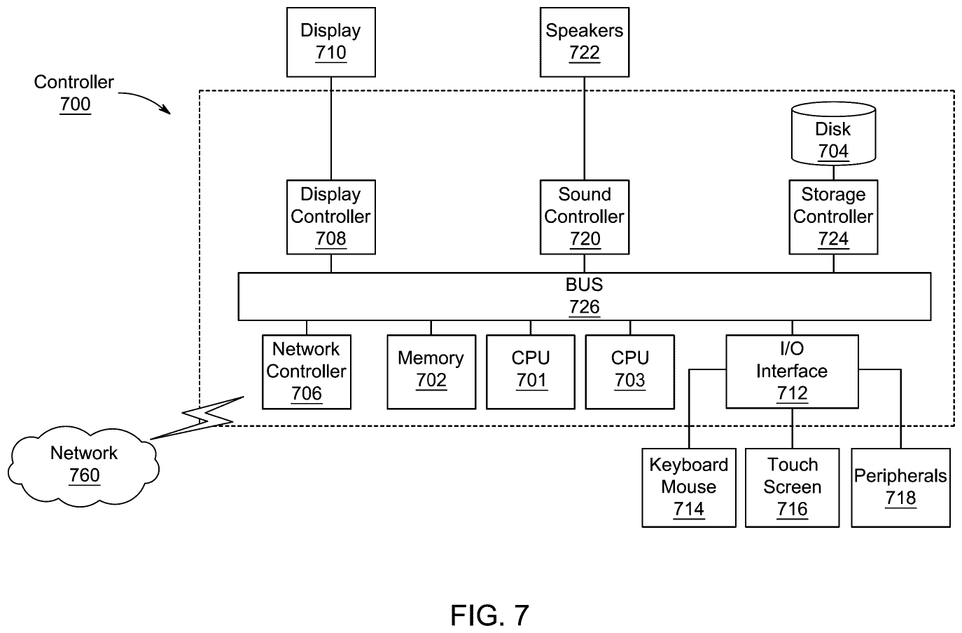

Next, further details of the hardware description of a computing environment according to exemplary embodiments is described with reference to FIG. 7. In FIG. 7, a controller 700 is described is representative of the secure controller 122 of the security system 100, in which the controller 700 is a computing device which includes a CPU 701 which performs the processes described above. The process data and instructions may be stored in memory 702. These processes and instructions may also be stored on a storage medium disk 704 such as a hard drive (HDD) or portable storage medium or may be stored remotely.

Further, the present disclosure is not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the present disclosure may be provided as a utility application, background daemon, or component of an operating system, or combination thereof, executing in conjunction with CPU 701, 703 and an operating system such as Microsoft Windows 7, Microsoft Windows 8, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 701 or CPU 703 may be a Xenon or Core processor from Intel of America or an Opteron processor from AMD of America, or may be other processor types that would be recognized by one of ordinary skill in the art. Alternatively, the CPU 701, 703 may be implemented on an FPGA, ASIC, PLD or using discrete logic circuits, as one of ordinary skill in the art would recognize. Further, CPU 701, 703 may be implemented as multiple processors cooperatively working in parallel to perform the instructions of the inventive processes described above.

The computing device in FIG. 7 also includes a network controller 706, such as an Intel Ethernet PRO network interface card from Intel Corporation of America, for interfacing with network 760. As can be appreciated, the network 760 can be a public network, such as the Internet, or a private network such as an LAN or WAN network, or any combination thereof and can also include PSTN or ISDN sub-networks. The network 760 can also be wired, such as an Ethernet network, or can be wireless such as a cellular network including EDGE, 3G, 4G, 5G and 6G wireless cellular systems. The wireless network can also be WiFi, Bluetooth, or any other wireless form of communication that is known.

The computing device further includes a display controller 708, such as a NVIDIA Geforce GTX or Quadro graphics adaptor from NVIDIA Corporation of America for interfacing with display 710, such as a Hewlett Packard HPL2445w LCD monitor. A general purpose I/O interface 712 interfaces with a keyboard and/or mouse 714 as well as a touch screen panel 716 on or separate from display 710. General purpose I/O interface also connects to a variety of peripherals 718 including printers and scanners, such as an OfficeJet or DeskJet from Hewlett Packard.

A sound controller 720 is also provided in the computing device such as Sound Blaster X-Fi Titanium from Creative, to interface with speakers/microphone 722 thereby providing sounds and/or music.

The general purpose storage controller 724 connects the storage medium disk 704 with communication bus 726, which may be an ISA, EISA, VESA, PCI, or similar, for interconnecting all of the components of the computing device. A description of the general features and functionality of the display 710, keyboard and/or mouse 714, as well as the display controller 708, storage controller 724, network controller 706, sound controller 720, and general purpose I/O interface 712 is omitted herein for brevity as these features are known.

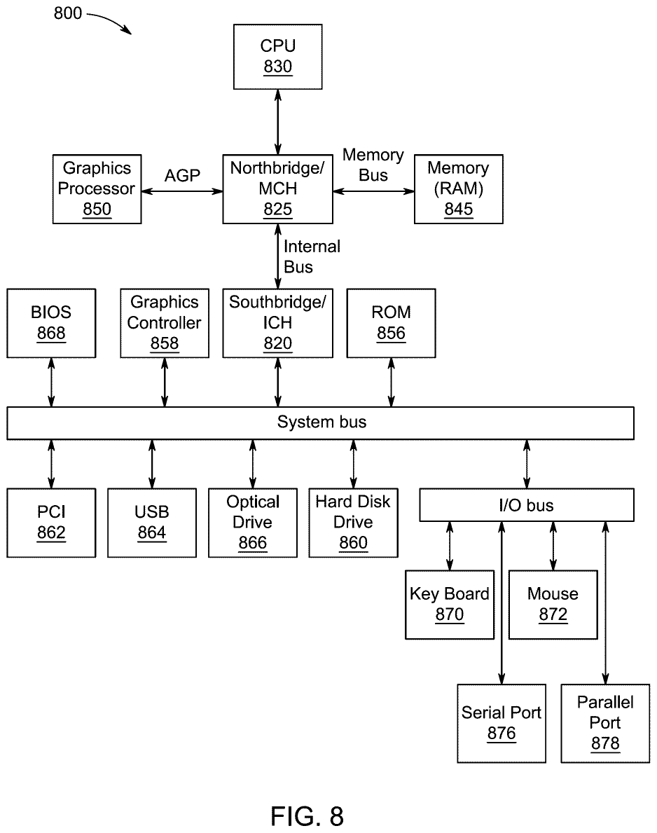

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 8.

FIG. 8 shows a schematic diagram of a data processing system, according to certain embodiments, for performing the functions of the exemplary embodiments. The data processing system is an example of a computer in which code or instructions implementing the processes of the illustrative embodiments may be located.

In FIG. 8, data processing system 800 employs a hub architecture including a north bridge and memory controller hub (NB/MCH) 825 and a south bridge and input/output (I/O) controller hub (SB/ICH) 820. The central processing unit (CPU) 830 is connected to NB/MCH 825. The NB/MCH 825 also connects to the memory 845 via a memory bus, and connects to the graphics processor 850 via an accelerated graphics port (AGP). The NB/MCH 825 also connects to the SB/ICH 820 via an internal bus (e.g., a unified media interface or a direct media interface). The CPU Processing unit 830 may contain one or more processors and even may be implemented using one or more heterogeneous processor systems.

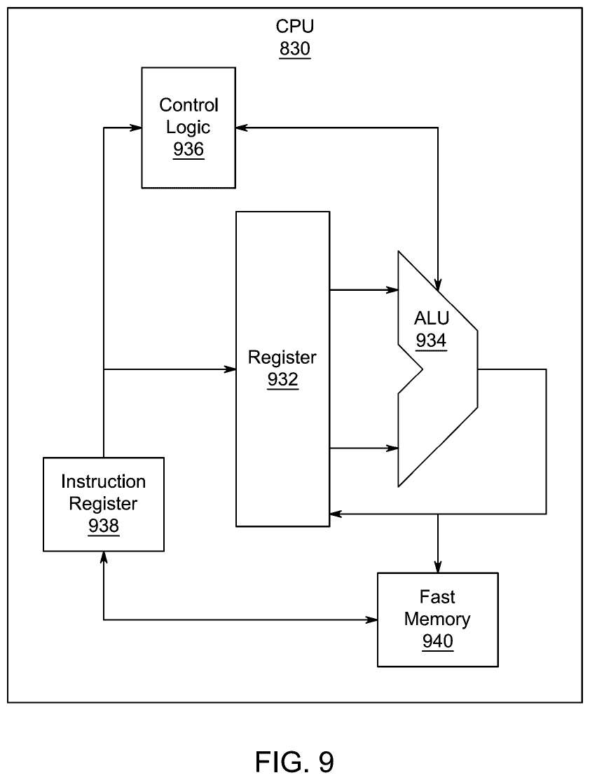

For example, FIG. 9 shows one implementation of CPU 830. In one implementation, the instruction register 938 retrieves instructions from the fast memory 940. At least part of these instructions are fetched from the instruction register 938 by the control logic 936 and interpreted according to the instruction set architecture of the CPU 830. Part of the instructions can also be directed to the register 932. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 934 that loads values from the register 932 and performs logical and mathematical operations on the loaded values according to the instructions. The results from these operations can be feedback into the register and/or stored in the fast memory 940. According to certain implementations, the instruction set architecture of the CPU 830 can use a reduced instruction set architecture, a complex instruction set architecture, a vector processor architecture, a very large instruction word architecture. Furthermore, the CPU 830 can be based on the Von Neuman model or the Harvard model. The CPU 830 can be a digital signal processor, an FPGA, an ASIC, a PLA, a PLD, or a CPLD. Further, the CPU 830 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 8, the data processing system 800 can include that the SB/ICH 820 is coupled through a system bus to an I/O Bus, a read only memory (ROM) 856, universal serial bus (USB) port 864, a flash binary input/output system (BIOS) 868, and a graphics controller 858. PCI/PCIe devices can also be coupled to SB/ICH 888 through a PCI bus 862.

The PCI devices may include, for example, Ethernet adapters, add-in cards, and PC cards for notebook computers. The Hard disk drive 860 and CD-ROM 866 can use, for example, an integrated drive electronics (IDE) or serial advanced technology attachment (SATA) interface. In one implementation the I/O bus can include a super I/O (SIO) device.

Further, the hard disk drive (HDD) 860 and optical drive 866 can also be coupled to the SB/ICH 820 through a system bus. In one implementation, a keyboard 870, a mouse 872, a parallel port 878, and a serial port 876 can be connected to the system bus through the I/O bus. Other peripherals and devices that can be connected to the SB/ICH 820 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

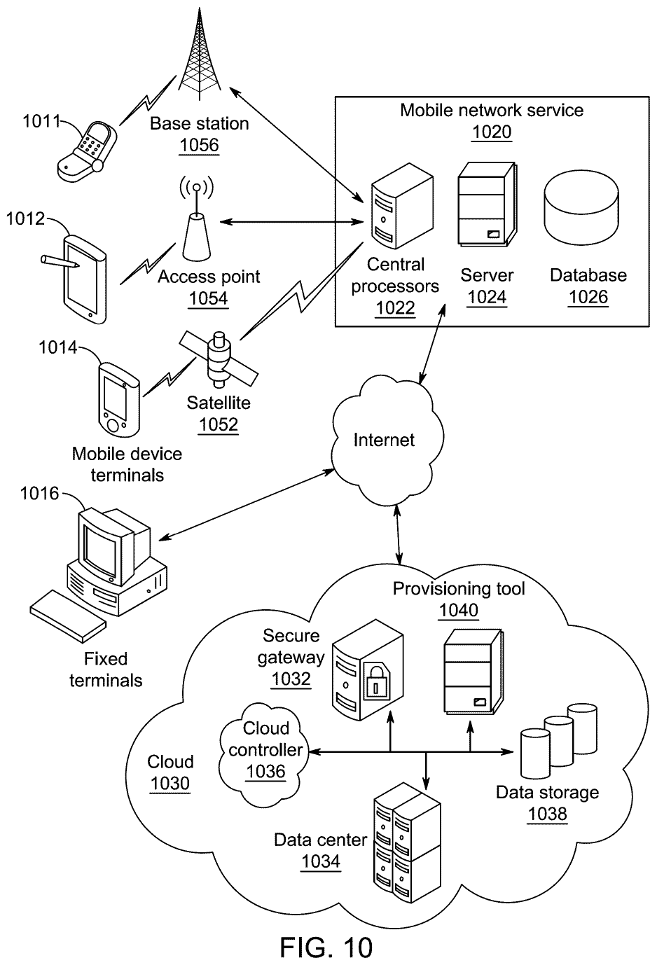

The functions and features described herein may also be executed by various distributed components of a system. For example, one or more processors may execute these system functions, wherein the processors are distributed across multiple components communicating in a network. The distributed components may include one or more client and server machines, such as cloud 1030 including a cloud controller 1036, a secure gateway 1032, a data center 1034, data storage 1038 and a provisioning tool 1040, and mobile network services 1020 including central processors 1022, a server 1024 and a database 1026, which may share processing, as shown by FIG. 10, in addition to various human interface and communication devices (e.g., display monitors 1016, smart phones 1010, tablets 1012, personal digital assistants (PDAs) 1014). The network may be a private network, such as a LAN, satellite 1052 or WAN 1054, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

While specific embodiments of the invention have been described, it should be understood that various modifications and alternatives may be implemented without departing from the spirit and scope of the invention. For example, different cellular automata rules or encryption algorithms could be employed, or alternative feature extraction and face recognition techniques could be integrated into the system.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A security system for a file system, comprising:
a host computer running a host operating system, and running a plurality of hosted virtual machines (VMs) as an intermediate connection to isolate the host operating system from external networks; and
a plurality of cloud services having indirect connections to the host computer facilitated by the host operating system,
wherein the plurality of VMs are configured to systematically back up data to the plurality of cloud services,
wherein the plurality of VMs are interconnected to each other via an internal virtual private network,
wherein a designated VM serves as a network gateway and manages traffic flow between the internal virtual private network and the external networks, including maintaining network security,
wherein the host computer includes a secure controller configured as a bridge between user applications and the host operating system to enforce security protocols and manage core operations to ensure system integrity in the host computer, and
wherein the secure controller is configured to manage interactions between the plurality of VMs and the plurality of cloud services.

2. The security system of claim 1, wherein the designated VM is equipped with a Bridged Network Adapter for external access to the internet and an Internal Network Adapter for internal VM communications.

3. The security system of claim 1, wherein the secure controller employs Moving Target Defense (MTD) for encoding files in the file system and secret sharing.

4. The security system of claim 1, wherein the secure controller is configured to manage VM deployment, performance, and resource allocation while enforcing security policies, by continuously monitoring the plurality of VMs for indications of corruption or malicious activities.

5. The security system of claim 3, wherein the file system is a host file system,
wherein the secure controller manages a write command which instructs the host file system to perform a write operation, storing an original file, and concurrently initiating a backup process using the MTD, including dividing the original file into shares and distributing the shares among the VMs, and
wherein each VM uploads its respective share to a designated cloud storage.

6. The security system of claim 5, further comprising a host file system,
wherein the secure controller manages a read command which instructs the host file system to perform a read operation, requesting a specified file from the host file system, and
wherein if the specified file is not found, the secure controller initiates file recovery using the MTD.

7. The security system of claim 6,
wherein the MTD-based file recovery includes retrieving, by the secure controller, the file shares from VMs,
wherein the secure controller seeks the corresponding share from the cloud storage, and
wherein the secure controller determines whether the retrieved shares are enough for file reconstruction.

8. The security system of claim 3, wherein the secure controller employs MTD including strategies of increasing diversity, shuffling parameters, adding redundancy, or using hybrid techniques that combine diversity, shuffling and redundancy.

9. The security system of claim 1, wherein a hypervisor performs VM migration at specified intervals based on a trigger from an Intrusion Detection System,
wherein the hypervisor
selects a destination host to which an infected VM will be migrated, and
deletes the infected VM on the host computer.

10. The security system of claim 9, wherein the hypervisor further
uploads file shares from the file system to an added VM to maintain data integrity, and
updates a configuration of the network and connects the added VM to a cloud network.

11. A method of securing a file system, comprising:
running a host operating system, on a host computer;
running a plurality of hosted virtual machines (VMs), on the host computer, as an intermediate connection to isolate the host operating system from external networks;
systematically back up data, by the plurality of VMs, to a plurality of cloud services having indirect connections to the host computer facilitated by the host operating system;
managing traffic flow, by a designated VM, between an internal virtual private network and the external networks, including maintaining network security;
enforcing security protocols and managing core operations, by a bridge between user applications and the host operating system, to ensure system integrity in the host computer; and
managing, by the secure controller, interactions between the plurality of VMs and the plurality of cloud services.

12. The method of claim 11, further comprising accessing the internet, using the designated VM equipped with a Bridged Network Adapter; and
conducting internal VM communications using an Internal Network Adapter.

13. The method of claim 11, further comprising encoding, by the secure controller, files in the file system and secret sharing using Moving Target Defense (MTD).

14. The method of claim 11, further comprising managing VM deployment, performance, and resource allocation, by the secure controller, while enforcing security policies, by continuously monitoring the plurality of VMs for indications of corruption or malicious activities.

15. The method of claim 13, wherein the file system is a host file system, the method further comprising
managing, by the secure controller, a write command which instructs the host file system to perform a write operation, storing an original file, and concurrently initiating a backup process using the MTD, including dividing the original file into shares and distributing the shares among the VMs; and
uploading, by each VM, a respective share to a designated cloud storage.

16. The method of claim 15, further comprising a host file system,
managing, by the secure controller, a read command which instructs the host file system to perform a read operation, by requesting a specified file from the host file system; and
when the specified file is not found, the secure controller initiates file recovery using the MTD.

17. The method of claim 16,
wherein the MTD-based file recovery includes retrieving, by the secure controller, the file shares from VMs;
seeking, by the secure controller, the corresponding share from the cloud storage; and
determining, by the secure controller, whether the retrieved shares are enough for file reconstruction.

18. The method of claim 13, further comprising employing, by the secure controller, MTD including strategies of increasing diversity, shuffling parameters, adding redundancy, or using hybrid techniques that combine diversity, shuffling and redundancy.

19. The method of claim 11, further comprising:
performing, by a hypervisor, VM migration at specified intervals based on a trigger from an Intrusion Detection System;
selecting, by the hypervisor, a destination host to which an infected VM will be migrated; and
deleting, by the hypervisor, the infected VM on the host computer.

20. The method of claim 19, further comprising:
uploading, by the hypervisor, file shares from the file system to an added VM to maintain data integrity; and
updating, by the hypervisor, a configuration of the network and connecting the added VM to a cloud network.
